(19) United States
(12) Patent Application Publication
(10) Pub. No.: US 2003/0015993 A1
(43) Pub. Date: Jan. 23, 2003

(54) Battery charging system with electronic logbook

(76) Inventors: Sudhan Misra, North Wales, PA (US); Stephen Mraz, Warrington, PA (US); Terrence Noveske, Pipersville, PA (US); Gregory Reich, Schwenksville, PA (US)

Correspondence Address: SALOVATORE J ABBRUZZESE, HOFFMANN & BARON LLP, 6900 JERICHO TURNPIKE, SYOSSET, NY, 11791, US

(21) Appl. No.: 09/908,310

(22) Filed: Jul. 17, 2001

(51) Int. Cl. H02J 7/00

(52) U.S. Cl. 320/125

(57) ABSTRACT

A battery charging system includes a battery management module and a battery charger. The battery charging system provides controlled charging in accordance with an algorithm utilizing historical battery data. The historical battery data is data pertaining to the historical status of the battery, and is acquired while the battery is in service and during previous charge cycles. The historical battery data is stored in memory in the battery management module. In one embodiment of the battery charging system, the battery management module is physically and electrically coupled to the battery during service and during charging. The historical battery data is provided to the battery charger during charging. The historical battery data is used to provide parameters to a charging algorithm, wherein the battery charging system provides controlled charging of the battery in accordance with the algorithm.

### FIELD OF THE INVENTION

This invention relates to battery charging systems, and specifically to battery charging systems providing controlled charging in accordance with stored accumulated battery parameters.

### BACKGROUND

Two important aspects of battery chargers are the conversion technology used to charge the battery, and charge termination. Various types of power conversion technologies are utilized today for motive power battery chargers. These technologies include passive ferro-resonant chargers, controlled ferro-resonant chargers, saturable reactor chargers, silicon controlled rectifier (SCR) chargers, and switching mode chargers.

Typical power conversion devices utilizing these technologies provide either constant power to the battery (i.e., constant current and voltage) via a transformer, for example, or they provide predetermined values of current and voltage via active electronics. Typical charge termination techniques terminate charging when a predetermined amount of time is reached, a predetermined voltage is measured, or when a predetermined rate of change of voltage (dv/dt) and/or current (di/dt) is measured.

A disadvantage of these power conversion devices and charge termination techniques is that power is provided in direct response to battery parameters, and not to parameters that indirectly affect the battery. This can result in inefficient charging. Further these devices and techniques tend to compensate for inefficiencies by increasing the amount of power provided to the battery. This lack of controlled charging can result in shortened battery life by grid corrosion, softening of positive active material, and excess water usage.

Controlled charging is a critical aspect of prolonging the life of a battery. This is particularly applicable to lead-acid traction batteries. Lead-acid batteries are affected both by under-charge and over-charge. Undercharging a lead-acid battery results in premature failure due to sulfating of the plates. Overcharging a lead-acid battery results in corrosion of the grids and promotes shedding of active material. Overcharging also results in excessive water loss, thus requiring increased maintenance of the battery.

Thus, a need exists for a controlled battery charging system that does not suffer the above disadvantages.

### SUMMARY OF THE INVENTION

A battery charging system charges a battery to one of a first state of charge and a second state of charge in accordance with historical battery data. The historical battery data represents the historical status of the battery.

A method for charging a battery includes acquiring and updating the historical battery data. The historical battery data is evaluated to determine if the battery requires charging. If the battery requires charging, it is determined if the battery requires full or normal charging. If the battery requires full charging, the battery is charged in accordance with a first charging process, and if the battery requires normal charging the battery charged in accordance with a second charging process. The historical battery data is then updated.

### BRIEF DESCRIPTION OF THE DRAWINGS

The invention is best understood from the following detailed description when read in connection with the accompanying drawings. The various features of the drawings may not be to scale. Included in the drawing are the following figures:

FIG. 1 is an illustration depicting the physical relationship between a battery management module, a battery, and a battery charger, in accordance with an exemplary embodiment of the invention;

FIG. 2 is a functional block diagram of an exemplary battery charging system coupled to a battery, in accordance with the present invention;

FIG. 3 is a diagram illustrating the various states of a an exemplary battery charging system in accordance with the present invention;

FIG. 4 is a flow diagram of an exemplary battery charging process in accordance with the present invention; and

FIG. 5 is a flow diagram of an exemplary process for determining if full charge criteria are met, in accordance with the present invention.

### DETAILED DESCRIPTION

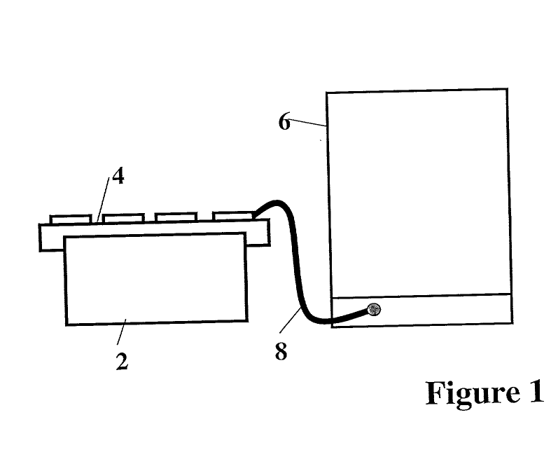

FIG. 1 is an illustration depicting an exemplary physical relationship between a battery management module 4, a battery 2, and a battery charger 6. Battery 2 is a rechargeable lead-acid battery. Battery 2 may be any rechargeable battery or number of rechargeable batteries. Battery management module 4 is shown mounted on battery 2. Battery management module 4 may be separate from battery 2. For explanatory purposes, battery 2 is assumed to be a lead-acid traction cell battery.

In an exemplary embodiment of the invention, battery management module 4 remains mounted on battery 2 while battery 2 is in use (e.g. discharging) and while the battery 2 is being charged. Prior to charging, battery 2 is disconnected from its platform and connected to battery charger 6. Battery charger 6 is connected to battery 2 and battery management module 4 by cable 8. Cable 8 provides charging current to battery 2, and provides data and control communication between battery management module 4 and battery charger 6. The depiction of cable 8 in FIG. 1 is exemplary. Other embodiments of the invention comprise various coupling means, including wireless coupling means such as electromagnetic (e.g., radio frequency) and optical (e.g., infrared).

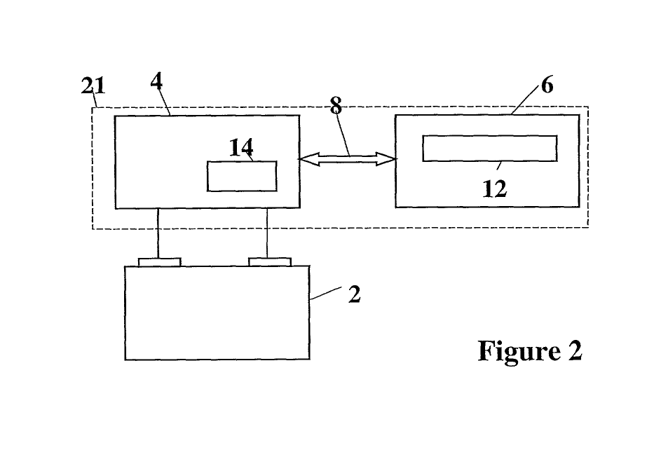

FIG. 2 is a functional block diagram of an exemplary battery charging system 21 coupled to a battery 2, in accordance with the present invention. The battery charging system 21 comprises battery management module 4 and battery charger 6. Battery management module 4 monitors and stores battery status data (e.g., historical data) in memory 14. The electronic log of battery status data stored in memory 14 is available to battery charger 6 when battery management module 4 and battery charger 6 are electrically coupled. During the charging process, battery charger 6 displays information pertaining to battery and charging status on display 12. Processors in both the battery management module 4 and the battery charger 6 (processors not shown) utilize battery parameter information stored in the memory 14 of the battery management module 4 to accomplish controlled charging of the battery 2. In an exemplary embodiment of the invention, the battery management module 4 is mechanically and electrically coupled to the battery 2 while the battery 2 is in service. In FIG. 2, the battery management module 4 and the battery charger 6 are depicted as separate devices. This depiction is exemplary. In an alternate embodiment of the invention, the battery management module 4 and the battery charger 6 are integrated into one device, wherein this one device is mechanically and electrically coupled to the battery 2 while the battery 2 is in service.

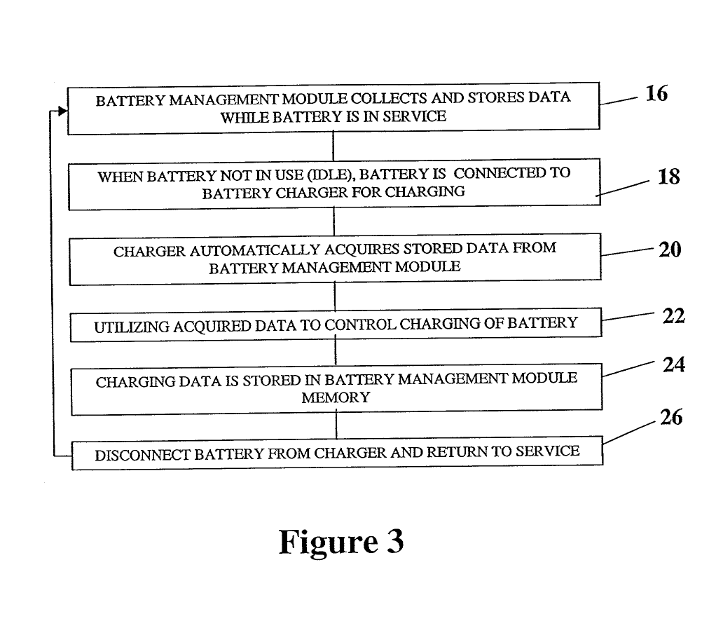

FIG. 3 is a diagram illustrating the various states of an exemplary battery charging system in accordance with the present invention. While battery 2 is in service (e.g., connected to a vehicle), battery management module 4 collects data pertaining to the status of the battery 2 and, stores this data in memory 14, as depicted in step 16. In preparation for charging, battery 2 is connected to battery charger 6, in step 18. In an exemplary embodiment of the invention, the battery management module 4 remains connected to battery 2 throughout all states depicted in FIG. 3. In step 20, battery charger 6 is connected to battery management module 4 and automatically acquires the data stored in memory 14. In step 22, this acquired data is used by battery charger 6 and battery management module 4 to control the charging of battery 2. Information pertaining to the charging of battery 2 is stored in memory 14 during the charging process, in step 24. In step 26, upon completion of the charging process, battery 2 is disconnected from battery charger 6 and returned to service.

Operating a lead-acid battery within a specific region of state of charge prolongs service time and total charge throughput of the battery. In an exemplary embodiment of the invention, to maintain a battery within this region, during charging, the battery is charged within a partial state of charge (PSOC) envelope, unless certain conditions are met, then the battery is charged to full charge. Charging a battery within a PSOC envelope enhances charge acceptance and impedes degradation of the battery's active ingredients. This charging process comprises a normal charge state and a full charge state. During the normal charge state, the battery is charged to values within the PSOC envelope. During the full charge state, the battery is charged to values approximately equal to the maximum allowable charge values for the battery. The PSOC envelope may vary depending upon specific battery type, condition, and parameters. In an exemplary embodiment of the invention, the battery is charged between a state of charge (SOC) of 45 and 99 percent of the battery's maximum allowable state of charge, during the normal charge process. In another embodiment of the invention, the battery is charged between a SOC of 80 and 99 percent of the battery's maximum allowable state of charge, during the normal charge process. In yet another embodiment of the invention, the battery is charged between a SOC of 90 and 95 percent of the battery's maximum allowable state of charge, during the normal charge process. To further increase battery life, it is recommended that the depth of discharge (DOD) of the battery not be allowed to exceed about 65 percent. This may be accomplished, for example, by scheduling battery charging after a specified number of hours of battery use.

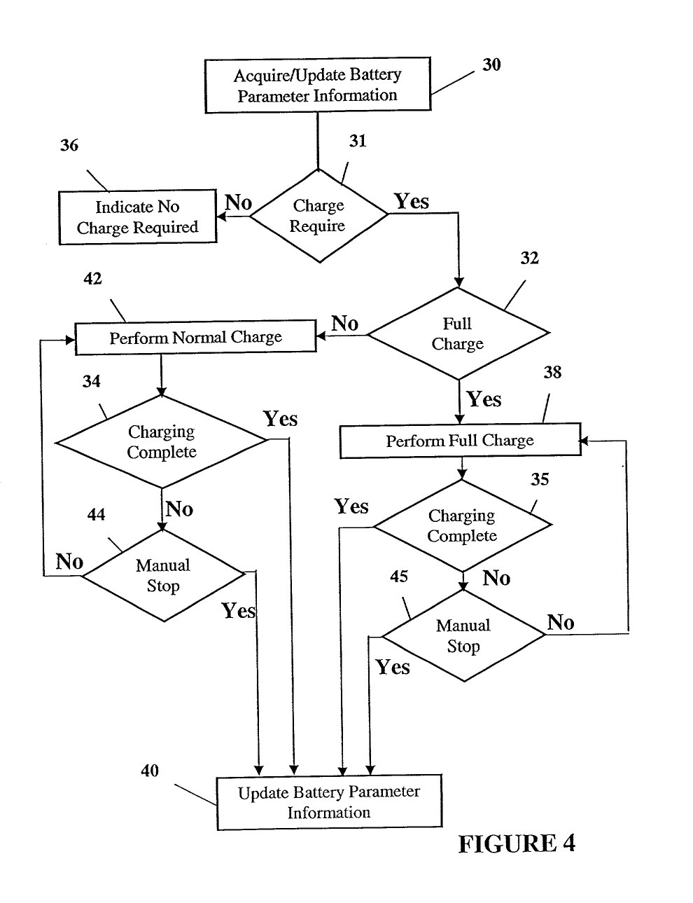

FIG. 4 is a flow diagram of an exemplary battery charging process in accordance with the present invention. In steps 30, 40, and 44, battery parameter information is acquired and updated. A portion of the battery parameters is acquired and updated prior to charging battery 2, as indicated in step 30. Also, a portion of the battery parameters is updated subsequent to charging the battery, as indicated in steps 40 and 44. Battery parameters are stored in memory 14 of battery management module 4 during service, and utilized during the controlled charging process. In steps 31, 32, and 34, these parameters are utilized to determine if battery 2 requires charging, and if battery 2 requires charge, whether the battery should undergo charging to a first state of charge (full charge) or charging to a second state of charge (normal charge).

In step 30, controlled charging of battery 2 is initiated by establishing communication between the battery management module 4 and battery charger 6. The charging process utilizes data pertaining to total charge and discharge history of battery 2, the most recent charge and discharge event, cumulative energy throughput during all the charge and discharge events, battery temperature, and average cell voltage. This data is stored in memory 14 of battery management module 4, and is available to charger 6 upon connection of battery charger 6 with battery management module 4. The following parameters, inter alia, are stored in memory 14 of battery management module 4. In the following list P1 represents parameter 1, P2 represents parameter 2, etc.

(P1) Battery type

(P2) Cumulative ampere-hours (Ah) discharged

(P3) Cumulative Ah charged

(P4) Date and time of last full charge

(P5) Number of total cycles recorded when the most recent full charge process was performed

(P6) Number of total cycles recorded when most recent charge process was performed

(P7) Cumulative Ah discharged since most recent full charge process was performed

(P8) Cumulative Ah charged since last full charge

(P9) Number of charge cycles completed

(P10) Number of charge cycles aborted

(P11) Number of low voltage events

Battery type (P1) is a parameter indicating the type of battery 2 connected to battery management module 4. Battery type may be, for example, sealed, flooded antimonial, or flooded non-antimonial. This parameter is set when the battery charging system 21 is calibrated for each battery 2, and is not altered thereafter.

Cumulative Ah discharged (P2) is a parameter indicating the total cumulative amount of discharge, in ampere-hours (Ah), of the battery 2. Prior to charging of battery 2 (during pre-charge delay), the current value of cumulative Ah discharged is read from memory 14. Also, the discharge of battery 2, in Ah, which occurred during the most recent service cycle, is read from memory 14. These two values are added and the sum, the total cumulative amount of discharge, is stored in memory 14, replacing the previous value of total cumulative amount of discharge.

Cumulative Ah charged (P3) is a parameter indicating the total cumulative amount of charge, in Ah, of the battery 2. Upon completion of the battery 2 being charged (during a cool down state), the charge of battery 2, in Ah, which occurred during the most recent charge cycle is stored in battery charger 6. This value is added to the current value of cumulative Ah charged stored in memory 14. The sum, the total cumulative amount of charge on battery 2, is stored in memory 14, replacing the previous value of total cumulative amount of charge.

Date and time of last full charge (P4) is a parameter indicating the date and time that the last full charge on battery 2 was completed. This value is updated upon completion of charging, during a cool down state.

Number of total cycles recorded when the most recent full charge process was performed (P5) is a parameter, which is updated upon completion of charging, during a cool down state. A total cycle is defined as a discharge followed by a recharge.

Number of total cycles recorded when the most recent charge process was performed (P6) is a parameter, which is updated upon completion of charging, during a cool down state. This parameter is incremented by battery management module 4, independent of battery charger 6. Thus, this parameter is incremented if a battery charger other than battery charger 6 were used to charge battery 2.

Cumulative Ah discharged since the most recent full charge process was performed (P7) is a parameter indicating the total cumulative amount of discharge, in Ah, of the battery 2 since the most recent full charge process was performed. Prior to charging of battery 2 (during pre-charge delay), the current value of cumulative Ah discharged since the most recent full charge process was performed is read from memory 14. The discharge of battery 2, in Ah, which occurred during the most recent service cycle, is read from memory 14. These two values are added and the sum, the total cumulative amount of discharge since the most recent full charge process was performed, is stored in memory 14, replacing the previous value of total cumulative amount of discharge since the most recent full charge process was performed. If a full charge process is performed during the charge process, this parameter is reset by storing a zero in memory 14. This parameter is reset, upon completion of charging, during a cool down state.

Cumulative Ah charged since most recent full charge process was performed (P8) is a parameter indicating the total cumulative amount of charge, in Ah, of the battery 2 since the most recent full charge process was performed. If a normal charge process was performed, the charge of battery 2, in Ah, which occurred during the most recent normal charge process, is stored in battery charger 6. This value is added to the current value of cumulative Ah charged since the most recent full charge process was performed, which is stored in memory 14. The sum, the total cumulative amount of charge on battery 2 since the most recent full charge process was performed, is stored in memory 14, replacing the previous value of total cumulative amount of charge since the most recent full charge process was performed. If a full charge process was performed during the charge process, this parameter is reset by storing a zero in memory 14, upon completion of charging, during a cool down state.

Number of charge cycles completed (P9) is a parameter indicating the number of charge cycles involving battery charger 6. Upon completion of charging, during a cool down state, this parameter is incremented by one, and the incremented value is stored in memory 14. This parameter is not incremented if the total number of charges recorded when most recent charged is greater than or equal to the current value of number of charge cycles completed. Thus, this parameter may be used to indicate that a charger other than battery charger 6 charged battery 2.

Number of charge cycles aborted (P10) is a parameter indicating the number of attempts to charge the battery 2, which were not completed. Examples of aborted events include disconnecting power to the charger 6 (e.g., pulling the plug), a power failure, and a battery failure.

Number of low voltage events (P11) is a parameter indicating the number of times the voltage on battery 2 has discharged to less than a specified value. In an exemplary embodiment of the invention, the specified value is 1.8 volts per cell. Battery discharge voltage, stored in memory, is examined during the pre-charge state. If the voltage value is less than the specified value, the parameter is incremented by one and stored in memory 14.

In step 31, it is determined if battery 2 requires charging. If the battery 2 does not require charging, an indication is displayed on display 12, indicating that no charge is required, as depicted in step 36. In step 32, it is determined if the criteria warranting full charging of battery 2 are met. If the full charge criteria are met, the battery 2 is charged in accordance with the full charge process, in step 38. If the full charge requirements are not met, and the battery requires charging, battery 2 is charged in accordance with the normal charge process, in step 42. The order of steps 32 and 42 as shown in FIG. 4, is exemplary. Steps 32 and 42 may be accomplished in any order. If the charging process is halted, either during the normal charging as depicted by step 42 or the full charging process as depicted by step 32, the battery charging system 21 determines if the charging process is complete. For normal charging, the determination as to whether the charging process is complete is depicted by step 34. For full charging, the determination as to whether the charging process is complete is depicted by step 35. In both steps 34 and 35, if the charging process is complete, battery parameters are accordingly updated and stored in memory 14 of battery management module 4 (step 40). If the charging process is not complete, the battery charging system determines if the charging process was manually stopped (steps 44 and 45). If the charging process was manually stopped, battery parameters are updated accordingly (e.g., P10 is incremented) in step 40. If the charging was not manually stopped, the battery charging system 21 continues the charging process at step 42 for normal charging and step 38 for full charging.

If the charge on battery 2 indicates that battery 2 has been minimally discharged during service, no charge is performed. An indication is sent to display 12, indicating that the battery 2 needs no charging. In an exemplary embodiment of the invention, to determine if the battery 2 requires charging, battery charger 6 acquires data stored in memory 14 on battery management module 4. The battery 2 is minimally discharged if the cumulative Ah discharged since the most recent full charge process was performed, P7, is less than or equal to a predetermined percentage of the battery's rated capacity since the most recent full charge. The predetermined percentage may fall within a range of values, dependent upon specific characteristics of the battery and conditions of use. In an exemplary embodiment of the invention, the predetermined value is ten percent, that is, the battery 2 is minimally discharged if the cumulative Ah discharged since the most recent full charge process was performed, P7, is less than or equal to ten percent (≦10%) of the battery's rated capacity since the most recent full charge of the battery's rated capacity. In another exemplary embodiment of the invention, the predetermined value is twenty percent.

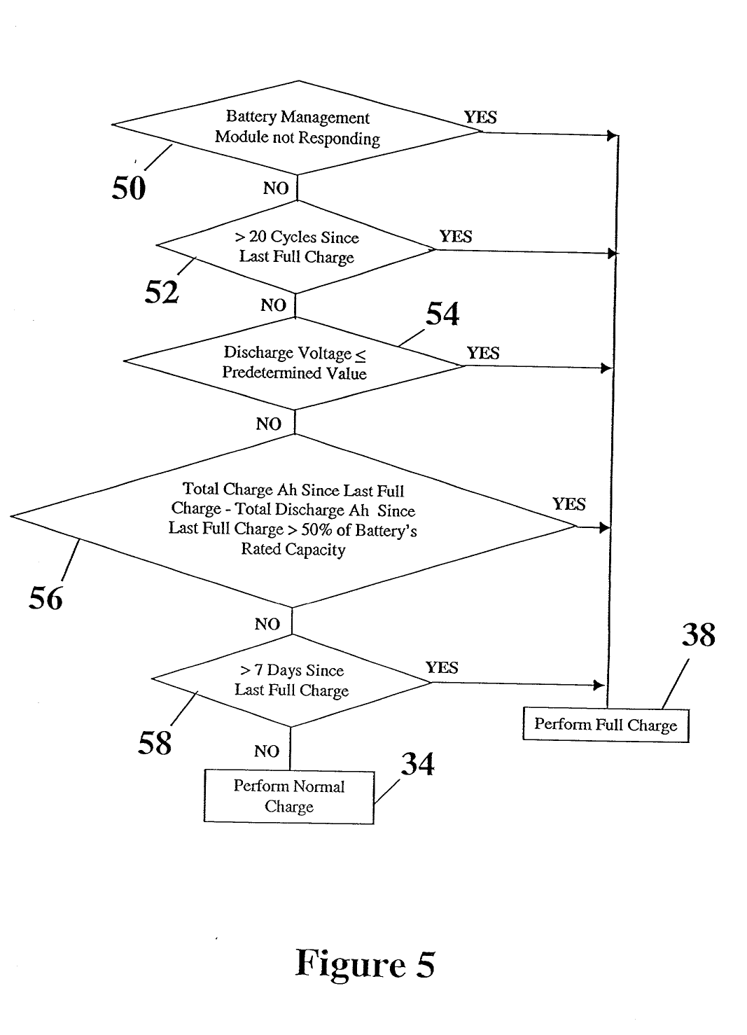

In step 32, status data stored in memory 14 on battery management module 4 are evaluated to determine if the full charge criteria are met. If the full charge criteria are met, the full charge process is performed (step 38). FIG. 5 is a flow diagram of an exemplary process for determining if full charge criteria are met, in accordance with the present invention. In step 50, if the battery management module 4 does not respond to battery charger 6, or data stored in memory 14 can not be acquired, battery 2 is charged in accordance with the full charge process. Also, an indication is sent to display 12 indicating an error.

In step 52, the number of total cycles since the most recent full charge is checked (P6-P5). If this number is greater than a predetermined value, the full charge process is performed. In an exemplary embodiment of the invention, the predetermined value is 20.

In step 54, if the volts per cell (vpc) of the battery 2, during discharge, is equal to or less than a predetermined value the full charge process is performed. In an exemplary embodiment of the invention, this predetermined valued is 1.80 volts per cell.

In step 56, the cumulative Ah charged and discharged since the most recent full charge are utilized to determine if battery 2 is to be fully charged. If the difference between the cumulative Ah charged since the most recent full charge, P8, and the cumulative Ah discharged since the most recent full charge, P7, is greater than a predetermined percentage of the battery's rated capacity, the full charge process is performed. In an exemplary embodiment of the invention, the predetermined percentage is 50%.

In step 58, the date and time of the most recent full charge, P4, is checked to determine if greater than a predetermined number of days has elapsed. In an exemplary embodiment of the invention, the predetermined number of days is seven. Thus, in this embodiment, if greater than seven days has elapsed between the most recent full charge and the date and time of the present charge process, the full charge process is performed.

The full charge process (step 38) is performed in accordance with algorithms stored in the charger 6. Various full charge processes may be incorporated in accordance with the present invention. One such process is a three-stage charging process, know as an IEI process. An IEI charging process, as is well known in the art, comprises charging the battery at a constant current during a first stage of charging, charging the battery at a constant voltage during a second stage of charging, and charging the battery at a constant current during the third stage of charging. In another embodiment of the invention, the full charge process comprises charging the battery at predetermined rates of change of electrical current and voltage. These rates of change include first and higher order derivatives with respect to time (e.g., di/dt, dv/dt, d²i/dt², d²v/dt², etc). Also envisioned is the full charge process comprises charging the battery in accordance with statistical measurements of the charging current and voltage (e.g., mean, variance, standard deviation, kurtosis, etc.). After the full charge process is complete, the battery parameters stored in memory 14 on battery management module 4 are updated at step 40.

If the full charge criteria are not met, and the battery requires charging, the battery is charged in accordance with the normal charge process (step 42). Various normal charge processes may be incorporated in accordance with the present invention. In an exemplary embodiment of the invention, the normal charge process comprises charging the battery with the PSOC envelope as described herein. In another exemplary embodiment of the invention, the normal charge process comprises charging the battery until the battery's measured state of charge is approximately 95% of the battery's rated capacity. In yet another exemplary embodiment of the invention, the normal charge process comprises charging the battery until an average voltage value of 2.45 volts per cell is attained.

During an exemplary typical charging process, the charging system 21 may transition to various states including a precharge state, a full charge state, a normal charge state, a cool down state, and a post charge state. During the precharge state, the battery charger 6 senses that a battery 2 has been connected. Parameters stored in memory 14 of battery memory module 4 are acquired by battery charger 6 during this precharge state (e.g., P1-P11). If the charge on the battery indicates that battery has been minimally discharged during service, no charge is performed. An indication is sent to display 12, indicating that the battery needs no charging.

During the charge state the battery charger 6 charges the battery 2 in accordance with one of the normal charge process or the full charge process as determined by evaluating historical battery status data stored in memory 14 of battery memory module 4. The battery is allowed to cool down during the cool down state. The battery is not charged by battery charger 6 during the cool down state. The cool down state is usually entered prior to the battery being placed into service. A timer may be set to determine the amount of time the battery charging system 21 remains in the cool down state. Alternatively, the battery is kept in the cool down state until the battery is equal to or below a predetermined temperature. In an exemplary of the invention, the cool down state is entered if the battery under charge is overheated. During the post charge state, memory 14 in battery management module 4 is updated and the charging process is terminated.

The present invention may be embodied in the form of computer-implemented processes and apparatus for practicing those processes. The present invention may also be embodied in the form of computer program code embodied in tangible media, such as floppy diskettes, read only memories (ROMs), CD-ROMs, hard drives, high density disk, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over the electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

Note that specific predetermined values and parameter values disclosed herein are exemplary. One of ordinary skill in the art can readily determine specific constants, values, and thresholds to meet the objects of the invention without undue experimentation. The values specified lie on a continuum and implementation involves choosing a point or point in the continuum.

Although the invention has been described in terms of exemplary embodiments, it is not limited thereto. Rather, the invention includes other variants and embodiments, which may be made by those skilled in the art without departing from the scope and range of equivalents of the invention.

What is claimed is:

1. A battery charging system for charging a battery to one of a first state of charge and a second state of charge in accordance with historical battery data, said historical battery data representing a history of battery status.

2. A battery charging system in accordance with claim 1, comprising:
a battery management module for acquiring, storing, providing, and updating said historical battery data, said battery management module being adapted for coupling to said battery,
a battery charger adapted for coupling to said battery management module, wherein said battery charger provides electrical current and charges said battery to one of said first state of charge and said second state of charge in accordance with said historical battery data.

3. A battery charging system in accordance with claim 2, wherein said battery management module is coupled to said battery during service and during charging.

4. A battery charging system in accordance with claim 3, wherein said coupling is mechanical and electrical.

5. A battery charging system in accordance with claim 1, wherein said battery is charged to one of a state of charge between 45 and 99 percent, inclusively, of said battery's maximum allowable state of charge and a state of charge equal to approximately said battery's maximum allowable state of s charge.

6. A battery charging system in accordance with claim 1, wherein said battery is charged to one of a state of charge between 80 and 99 percent, inclusively, of said battery's maximum allowable state of charge and a state of charge equal to approximately said battery's maximum allowable state of charge.

7. A battery charging system in accordance with claim 1, wherein said battery is charged to one of a state of charge between 90 and 95 percent, inclusively, of said battery's maximum allowable state of charge and a state of charge equal to approximately said battery's maximum allowable state of charge.

8. A battery charging system in accordance with claim 1, wherein said battery is a lead-acid battery.

9. A battery charging system in accordance with claim 8, wherein said lead-acid battery is one of a traction cell, sealed, flooded antimonial, and flooded non-antimonial.

10. A battery charging system in accordance with claim 1, wherein said historical battery data comprise at least one of the group consisting of battery type, cumulative ampere-hours discharged, cumulative ampere-hours charged, date and time of last charge to said first state of charge, number of total cycles recorded when most recent charge to said first state of charge was performed, number of total cycles recorded when most recent charge process was performed, cumulative ampere-hours discharged since most recent charge to said first state of charge, cumulative ampere-hours charged since last charge to said first state of charge, number of charge cycles completed, number of charge cycles aborted, and number of low voltage events.

11. A method for charging a battery, said method comprising:
acquiring historical battery data, said historical battery data representing a history of battery status; and
evaluating said historical battery data and accordingly determining if said battery requires charging.

12. A method in accordance with claim 11, further comprising:
updating said historical battery data;
indicating that said battery does not require charging, if said battery does not require charging;
determining if said battery requires charging to a first state of charge or a second state of charge, if said battery requires charging;
charging said battery in accordance with a first charging process, if said battery requires charging to said first state of charge;
charging said battery in accordance with a second charging process, if said battery requires charging to said second state of charge; and
providing said historical battery data.

13. A method in accordance with claim 11, wherein said historical battery data comprise at least one of the group consisting of battery type, cumulative ampere-hours discharged, cumulative ampere-hours charged, date and time of last charge to said first state of charge, number of total cycles recorded when most recent charge to said first state of charge was performed, number of total cycles recorded when most recent charge process was performed, cumulative ampere-hours discharged since most recent charge to said first state of charge, cumulative ampere-hours charged since last charge to said first state of charge, number of charge cycles completed, number of charge cycles aborted, and number of low voltage events.

14. A method in accordance with claim 11, wherein said battery requires charging if a cumulative ampere-hours discharged since a most recent charge to said first state of charge was performed is greater than a predetermined value of said battery's maximum allowable ampere-hours discharged since the most recent charge to said first state of charge.

15. A method in accordance with claim 14, wherein said predetermined value is 10 percent.

16. A method in accordance with claim 12, wherein said first charging process comprises charging said battery to the battery's approximately maximum allowable state of charge.

17. A method in accordance with claim 12, wherein said second charging process comprises charging said battery to a state of charge between 45 and 99 percent, inclusively, of said battery's maximum allowable state of charge.

18. A method in accordance with claim 12, wherein said second charging process comprises charging said battery to a state of charge between 80 and 99 percent, inclusively, of said battery's maximum allowable state of charge.

19. A method in accordance with claim 12, wherein said second charging process comprises charging said battery to a state of charge between 90 and 95 percent, inclusively, of said battery's maximum allowable state of charge.

20. A method in accordance with claim 12, wherein said battery requires charging to said first state of charge if:
a number of total cycles since a most recent charge to said first state of charge is greater than 20; or
during a discharge state of said battery, a voltage of said battery is less than or equal to a predetermined value; or
a difference between a cumulative ampere-hours charged since the most recent charge to said first state of charge and a cumulative ampere-hours discharged since the most recent charge to said first state of charge is greater than 50 percent of said battery's rated capacity; or
greater than seven days has elapsed since the most recent charging to said first state of charge.

21. A method in accordance with claim 20, wherein said predetermined value is 1.8 volts per cell.

22. A program storage device readable by machine, tangibly embodying a program of instructions executable by the machine to cause the machine to perform the steps of:
acquiring historical battery data, said historical battery data representing a history of battery status; and
evaluating said historical battery data and accordingly determining if said battery requires charging.

23. A program storage device in accordance with claim 22, wherein said program of instruction executable by the machine further causes the machine to perform the steps of:
updating said historical battery data;
indicating that said battery does not require charging, if said battery does not require charging;
determining if said battery requires charging to one of a first state of charge and a second state of charge, if said battery requires charging;
charging said battery in accordance with a first charging process, if said battery requires charging to said first state of charge;
charging said battery in accordance with a second charging process, if said battery requires charging to said second state of charge; and
providing said historical battery data.

24. A program storage device in accordance with claim 22, wherein said historical battery data comprise at least one of the group consisting of battery type, cumulative ampere-hours discharged, cumulative ampere-hours charged, date and time of last charge to said first state of charge, number of total cycles recorded when most recent charge to said first state of charge was performed, number of total cycles recorded when most recent charge process was performed, cumulative ampere-hours discharged since most recent charge to said first state of charge, cumulative ampere-hours charged since last charge to said first state of charge, number of charge cycles completed, number of charge cycles aborted, and number of low voltage events.

25. A program storage device in accordance with claim 22, wherein said battery requires charging if a cumulative ampere-hours discharged since a most recent charge to said first state of charge was performed is greater than a predetermined value of said battery's maximum allowable ampere-hours discharged since the most recent charge to said first state of charge.

26. A program device in accordance with claim 25, wherein said predetermined value is 10 percent.

27. A program storage device in accordance with claim 23, wherein said first charging process comprises charging said battery to the battery's approximately maximum allowable state of charge.

28. A program storage device in accordance with claim 23, wherein said second charging process comprises charging said battery to a state of charge between 45 and 99 percent, inclusively, of said battery's maximum allowable state of charge.

29. A program storage device in accordance with claim 23, wherein said second charging process comprises charging said battery to a state of charge between 80 and 99 percent, inclusively, of said battery's maximum allowable state of charge.

30. A program storage device in accordance with claim 23, wherein said second charging process comprises charging said battery to a state of charge between 90 and 95 percent, inclusively, of said battery's maximum allowable state of charge.

31. A program storage device in accordance with claim 23, wherein said battery requires charging to said first state of charge if:
a number of total cycles since a most recent charge to said first state of charge is greater than 20; or
during a discharge state of said battery, a voltage of said battery is less than or equal to a predetermined value; or
a difference between a cumulative ampere-hours charged since the most recent charge to said first state of charge and a cumulative ampere-hours discharged since the most recent charge to said first state of charge is greater than 50 percent of said battery's rated capacity; or
greater than seven days has elapsed since the most recent charge to said first state of charge.

32. A program storage device in accordance with claim 31, wherein said predetermined value is 1.8 volts per cell.

33. A battery charging system comprising a computer usable medium having computer readable program code means embodied therein for charging a battery, the computer readable program code means in said battery charging system comprising computer readable program code means for causing a computer to effect:
acquiring historical battery data, said historical battery data representing a history of battery status;
updating said historical battery data;
evaluating said historical battery data and accordingly determining if said battery requires charging;
indicating that said battery does not require charging, if said battery does not require charging;
determining if said battery requires charging to one of a first state of charge and a second state of charge, if said battery requires charging;
charging said battery in accordance with a first charging process, if said battery requires charging to said first state of charge;
charging said battery in accordance with a second charging process, if said battery requires charging to said second state of charge; and
providing said historical battery data.

34. A battery charging system in accordance with claim 33, wherein said historical battery data comprise at least one of the group consisting of battery type, cumulative ampere-hours discharged, cumulative ampere-hours charged, date and time of last charge to said first state of charge, number of total cycles recorded when most recent charge to said first state of charge was performed, number of total cycles recorded when most recent charge process was performed, cumulative ampere-hours discharged since most recent charge to said first state of charge, cumulative ampere-hours charged since last charge to said first state of charge, number of charge cycles completed, number of charge cycles aborted, and number of low voltage events.

35. A battery charging system in accordance with claim 33, the computer readable program code in said battery charging system further comprising readable program code means for causing a computer to effect determining that said battery requires charging if a cumulative ampere-hours discharged since the most recent charge to said first state of charge was performed is greater than a predetermined value of said battery's maximum allowable ampere-hours discharged since the most recent charge to said first state of charge, else said battery requires charging.

36. A battery charging system in accordance with claim 35, wherein said predetermined value is 10 percent.

37. A battery charging system in accordance with claim 33, the computer readable program code in said battery charging system further comprising readable program code means for causing a computer to effect charging said battery until said battery is charged to one of a state of charge between 45 and 99 percent, inclusively, of said battery's maximum allowable state of charge and a state of charge equal to approximately said battery's maximum allowable state of charge.

38. A battery charging system in accordance with claim 33, the computer readable program code in said battery charging system further comprising readable program code means for causing a computer to effect charging said battery until said battery is charged to one of a state of charge between 80 and 99 percent, inclusively, of said battery's maximum allowable state of charge and a state of charge equal to approximately said battery's maximum allowable state of charge.

39. A battery charging system in accordance with claim 33, the computer readable program code in said battery charging system further comprising readable program code means for causing a computer to effect charging said battery until said battery is charged to one of a state of charge between 90 and 95 percent, inclusively, of said battery's maximum allowable state of charge and a state of charge equal to approximately said battery's maximum allowable state of charge.

40. A battery charging system in accordance with claim 33, the computer readable program code in said battery charging system further comprising readable program code means for causing a computer to effect determining said battery requires charging to said first state of charge if:
a number of total cycles since a most recent charge to said first state of charge is greater than 20; or
during a discharge state of said battery, a voltage of said battery is less than or equal to a predetermined value; or
a difference between a cumulative ampere-hours charged since the most recent charge to said first state of charge and a cumulative ampere-hours discharged since the most recent charge to said first state of charge is greater than 50 percent of said battery's rated capacity; or
greater than seven days has elapsed since the most recent charge to said first state of charge.

41. A battery charging system in accordance with claim 40, wherein said predetermined value is 1.8 volts per cell.
